(19) United States
(12) Patent Application Publication
(10) Pub. No.: US 2020/0036411 A1
(43) Pub. Date: Jan. 30, 2020

(54) VEHICLE COMPONENTS, SWITCH TO BE ARRANGED ON A VEHICLE COMPONENT, AND METHOD FOR PRODUCING A VEHICLE COMPONENT

(71) Applicant: TB Deu Abwicklungs-Aktiengesellschaft, Aschaffenburg (DE)

(72) Inventor: Marcus Ted Kandler, Aschaffenburg (DE)

(21) Appl. No.: 16/337,067

(22) PCT Filed: Sep. 28, 2017
(86) PCT No.: PCT/EP2017/074649

§ 371 Date: Mar. 27, 2019

(30) Foreign Application Priority Data
Sep. 29, 2016 (DE) 10 2016 218 874.7

(51) Int. Cl. H04B 5/00; H01Q 1/32; H01Q 7/00; B62D 1/04; B60Q 5/00

(52) U.S. Cl. CPC H04B 5/0031; H01Q 1/3291; B60Q 5/003; H04B 5/0081; B62D 1/046; H01Q 7/00

(57) ABSTRACT

It is provided a vehicle component, comprising a decorative element and at least one NFC antenna. The NFC antenna is at least partially arranged on a component of the decorative element and/or is at least partially formed by a component of the decorative element.

### CROSS-REFERENCE TO A RELATED APPLICATION

This application is a National Phase Patent Application of International Patent Application Number PCT/EP2017/074649, filed on Sep. 28, 2017, which claims priority of German Patent Application Number 10 2016 218 874.7, filed on Sep. 29, 2016.

### BACKGROUND

The disclosure relates to a vehicle component, a switch to be arranged on a vehicle component as well as a method for producing a vehicle component.

From the most recent background art, near-field-communication modules (NFC modules) are known, via which data can be transmitted with a short distance. Such NFC modules comprise an antenna for sending and/or receiving data.

### SUMMARY

The problem underlying the proposed solution is based on entails designing a data transmission system via NFC for a vehicle passenger in the simplest way possible.

The problem is solved by means of vehicle components with features as described herein, by means of the switch with features as described herein, as well as by means of the method with features as described herein.

In accordance with this, a vehicle component is provided, comprising
a decorative element; and
at least one NFC antenna, wherein
the NFC antenna is at least partially arranged on a component of the decorative element and/or is at least partially formed by a component of the decorative element.

By means of arranging the NFC antenna in the region of the decorative element or by means of the forming the NFC antenna via the decorative element, an integration, which is as inconspicuous as possible, of the NFC antenna into the vehicle takes place, wherein, nevertheless, the antenna can be easily accessible for a vehicle passenger. For example, the at least one NFC antenna for communication between the vehicle and a mobile telephone or another portable device (e.g. of a vehicle key or of another “wearable”). Thus, a driver of the vehicle can bring his/her mobile phone in the vicinity of the NFC antenna, whereupon this, for example, obtains an encrypted signal (in particular, a verification signal) for starting the vehicle. Thereafter, the cell phone sends a command (for example, via Bluetooth or Wi-Fi) to the vehicle, whereupon this starts, for example, and/or carries out another function, for example, activating a light source or a means for personal identification. The NFC antenna, in particular, has to do with an NFC antenna, meaning an antenna with features that correspond to the NFC standard. The NFC antenna is, in particular, connected to an NFC chip and/or a vehicle-side transmitter and receiver.

It is conceivable that the component of the decorative element, on which the NFC antenna is arranged or by means of which it is formed, is made of an electrically conductive material or comprises a coating consisting of an electrically conductive material (wherein, a main body of the decorative element provided with the coating is made of a plastic in particular). In particular, the electrically conductive material comprises a metal (e.g. aluminum or chrome). In particular, it is possible that a structure is formed within the electrically conductive material, meaning, for example, within the decorative element itself or in the coating, said structure at least partially forming the NFC antenna. For example, the electrically conductive material forming the NFC antenna is created via a galvanization process or with the aid of another deposition method (e.g. PVD—physical vapor deposition) or a printing method. The electrically conductive material is, for example, selectively applied in such a way that it forms the desired antenna structure. However, it is also possible that a metal coating is initially created, and this is then structured; e.g. via an etching or scratching method.

It is also conceivable that the NFC antenna is at least partially formed by means of a coil arranged on the component of the decorative element. Therein, the component, on which the coil has been attached, can, for example, be made of a plastic.

The decorative element has, for example, to do with a manufacturer emblem and/or a decorative ring.

In particular, it is possible that the NFC antenna is at partially arranged on a projection of the decorative element, which is arranged to apply a voltage in the case of the (e.g. galvanic) creating of a decorative element coating or is formed by the projection. For example, the decorative element has to do with the decorative ring already mentioned in the above, wherein the projection protrudes in particular from the ring in a radial manner towards the outside.

In accordance with another embodiment, the decorative element (in particular, in the region of the NFC antenna) comprises ferromagnetic elements that are formed and arranged in such a way that they support a guidance of an electromagnetic wave through the NFC antenna and/or shield the NFC antenna against exterior fields. Such ferromagnetic elements can be provided, in particular, in the case of wider conductive structures (e.g. structures with a width that is larger than 4 mm).

The ferromagnetic elements can also be used to adjust the resonance frequency and/or the bandwidth of the antenna. The change in resonance frequency and/or in bandwidth caused by the ferromagnetic elements can also be taken into consideration for the design of the decorative element (e.g. the NFC antenna); in particular, in order to prevent undesired eddy currents and thereby keep loss at the lowest level possible. The ferromagnetic elements can, for example, be implemented by means of a ferromagnetic paint arranged on the decorative element, an additional sintered part, a foil and/or an injection-molded piece. It is also possible that the decorative element itself is correspondingly designed to be ferromagnetic. Thereby, it is conceivable (e.g. in the case of solid aluminum plaques) that the decorative element is manufactured out of at least one ferromagnetic sintered part.

In particular, the vehicle component is a steering wheel, in particular, an airbag module of a steering wheel. However, it is also conceivable that the decorative element and, therefore, the NFC antenna is arranged on another vehicle component, for example, a dashboard or a center console of a vehicle.

In particular, the vehicle component also comprises a transmitter and/or a receiver connected to the NFC antenna. The transmitter and/or receiver already mentioned in the above particularly has to do with an electronic module (in particular, an integrated one). For example, the electronic module is an NFC chip, which, for example, is operated in a standalone manner, meaning without connecting to the vehicle. However, it is also possible that the transmitter and/or receiver is a component of the vehicle (for, example, the vehicle ECU) so that the NFC antenna is connected to the vehicle. The connection of the NFC antenna to the vehicle-side transmitter and/or receiver takes place, for example, directly or via an NFC chip. By means of the vehicle-side transmitter and/or receiver, for example, a configuration of an NFC chip connected to the NFC antenna can also take place.

The disclosure relates to a heating device and/or sensor device, wherein at least one part of a wire winding of the heating or of the sensor device forms an NFC antenna. For example, the vehicle component has to do with the steering wheel rim of a steering wheel, wherein, for example, at least one part of a heating wire running within the steering wheel rim forms the NFC antenna.

From another aspect, the disclosure relates to a switch to be arranged on a vehicle component with a probe element and an apparatus for detecting an actuation of the probe element, wherein the apparatus comprises an NFC antenna.

Thus, the apparatus is, for example, designed for the capacitive detection of the actuation, wherein an electrically conductive element of the apparatus forms the NFC antenna. It is also conceivable that the apparatus is designed for the inductive detection of the actuation, wherein an inductive element (in particular, a coil) of the apparatus forms the NFC antenna. Ultimately, the apparatus can also be designed for the mechanical detection of the actuation, wherein a strain gage for a resistive measurement for example, of the apparatus forms the NFC antenna.

In particular, it is possible that the switch is arranged in a steering wheel, wherein the switch is used to trigger a horn signal.

The disclosure furthermore relates to a method for producing a vehicle component as described above, wherein the method comprises the following steps:
providing or producing a decorative element, and
providing at least one NFC antenna, wherein
the NFC antenna is at least partially arranged on a component of the decorative element and/or is at least partially formed by a component of the decorative element.

For example, the arrangement of the NFC antenna on the component of the decorative element entails providing a component of the decorative element (in particular, an electrically insulating one), for example, of a carrier, and a coating of the component with an electrically conductive material, wherein the coating is generated and/or structured (e.g. by etching) in such a way that it at least partially forms the NFC antenna. It is also conceivable that a wire is arranged on the component of the decorative element. However, it is also possible, as is mentioned in the above, that the component consists of a conductive material (e.g. a metal) and is initially coated with an electrically insulating material. Then, the metallization or the arranging of the wire can take place.

For example, the carrier is made of a plastic. After generating the coating and the structuring to form the NFC antenna, at least one other material layer can be generated over the NFC antenna, which forms a visible surface for example.

### BRIEF DESCRIPTION OF THE DRAWINGS

The solution will be explained in more detail in the following by means of embodiments and with reference to the figures.

FIG. 1 shows a decorative ring with an NFC antenna of a vehicle component.

FIG. 2 shows a cross-section through a manufacturer emblem with an NFC antenna of a vehicle component.

FIG. 3 shows a cross-section through a section of another vehicle component.

FIG. 4 shows a cross-section through another decorative element of a vehicle component.

FIG. 5 shows a perspective view of a decorative element of a vehicle component.

FIG. 6 shows an equivalent circuit diagram of a decorative element of a vehicle component.

FIGS. 7A to 7D show variants of a decorative ring.

FIG. 8 shows a switch in accordance with a first embodiment.

FIG. 9 shows a switch in accordance with a second embodiment.

FIG. 10 shows a switch in accordance with a third embodiment.

FIG. 11 shows a switch with a piezo element.

### DETAILED DESCRIPTION

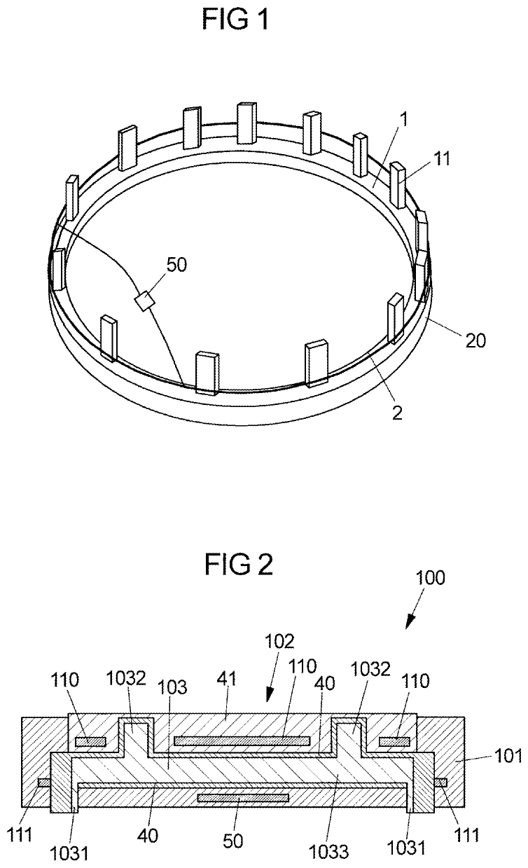

FIG. 1 shows a decorative element in the form of a decorative ring 1. The decorative ring 1 comprises a multiplicity of hook elements 11, via which the decorative ring 1 can be arranged on an airbag cap (not shown) of a steering wheel of a vehicle. A wire winding (coil) 2 runs along the outer sides of the hook elements 11, which forms an NFC antenna 20 (in particular, an NFC antenna). The NFC antenna 20 is connected to a transmitter and receiver in the form of a transmitter and receiver chip (NFC chip) 50. The decorative ring 1 is, in particular, a plastic component, which is provided on its outer side (in FIG. 1 below), which faces the vehicle interior—with reference to the state of the decorative ring installed within the vehicle—with a metallic coating.

In FIG. 2, a cross-section through a vehicle component according to an embodiment in the form of an airbag cap arrangement 100 of an airbag module for a steering wheel of a motor vehicle is shown. The airbag cap arrangement 100 comprises an airbag cover (airbag cap) 101 covering an airbag of the airbag module from the vehicle interior. The airbag cap arrangement 100 furthermore comprises a decorative element 102 with a manufacturer emblem plaque 103. The manufacturer emblem plaque 103 comprises structures 1032 (elevations and/or depressions), which represent a graphic (in particular, a logo). Furthermore, the plaque 103 comprises fastening elements in the form of hook elements 1031, which protrude from a main body 1033 of the plaque 103 and via which it is connected to the airbag cover 101, for example, via plastic welds.

The plaque 103 consists of metal (e.g. aluminum) for example, wherein an electrically insulating material coating 40, for example, in the form of a foil, can be arranged between the airbag cover 101 and the plaque 103. The material coating 40 surrounds the plaque 103 completely or only in sections. On the upper side of the plaque 103, which faces the vehicle interior in the mounted state, a paint coating 41 can be attached.

Furthermore, the airbag cap arrangement 100 comprises a coil 110 for forming an NFC antenna, which is arranged on the upper side of the plaque 103. For example, the coil 110 is at least partially surrounded by the paint coating 41. In addition or as an alternative, a coil 111 for forming an NFC antenna can be set around the hook elements 1031 of the plaque 103. The NFC antenna(s) formed by the coils 110 or 111 is, for example, connected to an NFC transmitter and/or receiver chip 50. The sender and/or receiver chip 50 is, for example, arranged in a section of the airbag cover 101 extending under the main body 1033 of the plaque 103. It is also possible that an illumination device is available for illuminating the plaque 103. An electrical connection to the coils 110, 111 takes place, for example, via the hook elements 1031.

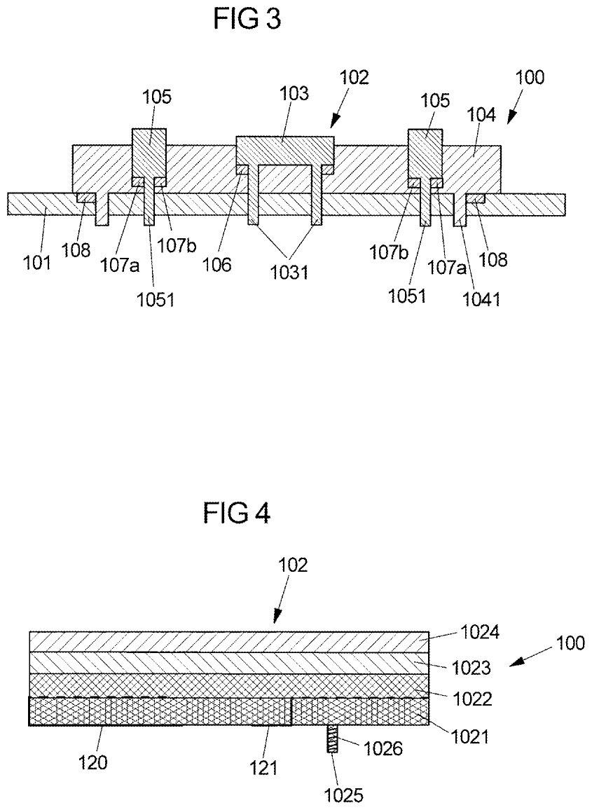

A cross-section through an airbag cap arrangement 100 in accordance with another embodiment is shown in FIG. 3. In turn, the airbag cap arrangement 100 comprises an airbag cover 101 covering an airbag of the airbag module from the vehicle interior.

The airbag cap arrangement 100 furthermore comprises a decorative element 102 with a first component in the form of a manufacturer emblem plaque 103, which is arranged on a second component of the decorative element 102 designed as a carrier 104. The manufacturer emblem plaque 103 is inserted into a depression of the carrier 104 and engages the carrier 104 with hook elements 1031. The plaque 103 is anchored in the airbag cover 101 via the hook elements 1031 (e.g. engaged and/or joined via a substance-to-substance bond). In addition to the decorative element 102, the airbag cap arrangement 100 comprises another decorative element, namely a decorative ring 105. The decorative ring 105 also comprises hook elements 1051, via which it is fixed to the airbag cover 101.

Furthermore, the airbag cap arrangement 100 comprises at least one NFC antenna. The NFC antenna is formed by a coil 106, which, for example, is wound around the hook elements 1031 of the plaque 103; for example, the coil 106 is located in an upper region of the hook elements 1031 abutting the plaque 103. In addition or as an alternative, an outer coil 107a could be wound around the hook elements 1051 of the decorative ring 105 at the outside to form the NFC antenna and/or an inner coil 107b could be inserted along an inner side of the hook elements 1051. In order to attach the inner coil 107b, the hook elements 1051 can comprise corresponding attachment structures. In particular, the inner and outer coil 107a, 107b represent separate antennas, the diameters of which differ from one another and which can be operated independently of one another. It is also conceivable that a coil 108 is wound around hook elements 1041, via which the carrier 104 is attached to the airbag cap 101, for forming the NFC antenna. Naturally, the three coils 106, 107, 108 can also be provided together in order to implement three NFC antennas. Naturally, the solution also comprises the case in which the airbag cap arrangement 100 only comprises two coils, and, therefore, two NFC antennas or more than three coils, therefore more than three NFC antennas.

The coils 106, 107, 108 are, for example, designed as a disorderly winding. For example, the hook elements 1031 are provided with and wrapped with an adhesive. However, in order to improve the fill factor, orthocyclic windings can be strived for, for example by means of a design of the hook elements 1031 favoring such windings. It is also conceivable that, initially, a disorderly winding is created on the decorative ring 105 or the plaque 103, which undergoes a compression due to inserting the decorative ring 105 and the plaque 103 into the carrier 104 and is thereby transformed into an orderly winding.

FIG. 4 shows a decorative element 102 of an airbag cap arrangement 100, said element manufactured by means of a multi-component injection-molding method. The decorative element 102 consists of a first plastic coating 1021; for example, in the form of a coating made of PC (polycarbonate) ABS (acrylonitrile butadiene styrene copolymer). A second plastic coating 1022 (e.g. made of PC or PC-ABS) is arranged on the first plastic coating 1021. A textured metal coating 1023 (e.g. a chrome coating), which forms a visible surface of the decorative element 102 is located on a side of the second plastic coating 1022 facing away from the first coating 1021. The metal coating 1023 can be protected by a transparent protective coating 1024. A paint or a resin (in particular, one that is not electrically conductive) can be used as a material for the protective coating 1024.

The metal coating 1023 is created by means of galvanizing for example, wherein an electrical voltage can be applied to the first and second plastic coating 1022, 1023 via a (e.g. pin-like) projection 1025 (“voltage apply pin”—VAP) originating from the first plastic coating 1022.

Furthermore, two metallic (in particular, coil-like) structures 120, 121, which each form an NFC antenna are located between the first and second plastic coating 1022, 1023. The metallic structures 120, 121, which are, for example, made of chrome, are, in particular, also created by means of galvanizing, wherein the antenna structures are produced by means of selective electroplating and/or subsequently structuring a galvanized coating. Furthermore, the metal coating 1023 can be created and/or subsequently structured in such a way that it forms part of an NFC antenna. It is also conceivable that only one of the metallic structures 120, 121 creates or only the structured metal coating 1023 forms an NFC antenna. Furthermore, the VAP 1025 can be used as a carrier of a coil 1026 for forming an NFC antenna.

It is also conceivable that more than two plastic coatings are created, wherein metal coatings are present at least between several of the plastic coatings to form NFC antennas. It is possible that a plurality of NFC antennas are formed, which have different characteristics (e.g. resonance frequencies) and, for example, are used for various functions.

A decorative element 102 is schematically shown in FIG. 5, which is constructed according to the “bolt-fix” principle. Accordingly, here, the decorative element 102 comprises a first component in the form of a manufacturer emblem plaque 103 and a second component in the form of a fixing element 130. After mounting the decorative element 102 on an airbag cover (not shown in FIG. 5), the fixing element 130 runs on an inner side of the airbag cover through eyelets 131 of the manufacturer emblem plaque 103, which extend through the airbag cover, thereby fixing the manufacturer emblem plaque 103 to the airbag cover. It is conceivable that the fixing element 130 is designed in such a way that it forms an NFC antenna and/or that at least one coil is attached to the fixing element 130 for forming at least one NFC antenna. The fixing element 130 is particularly made like a bolt, wherein, for example, a round, half-round, circular or (in particular rounded) rectangular coil can be arranged on the fixing element 130. It is also possible that an intermediate space exists between the decorative element 102 and the fixing element 130, which can be designed to specifically adapt to the emission characteristics of the NFC antenna. However, the fixing element 130 can also project over the (e.g. metal) decorative element 102, wherein the coil, for example, is at least partially arranged in the region of the fixing element 130 projecting beyond the decorative element 102 in order to minimize interferences by means of the decorative element 102.

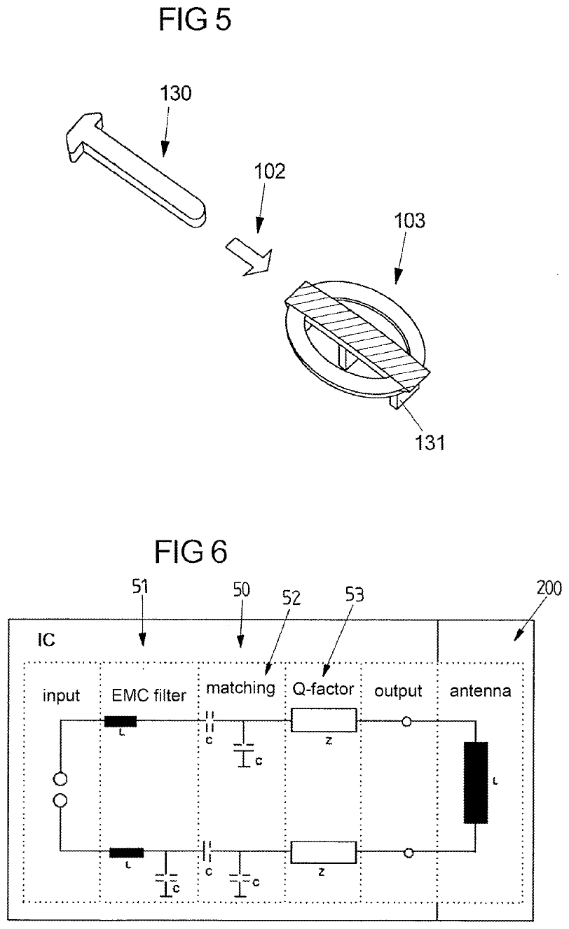

FIG. 6 shows an NFC antenna circuit 200 created using a vehicle component according to the solution. The circuit 200 comprises an IC 50, which provides an EMC filter 51 and a tuning circuit 52. In addition, a resistive, inductive and/or capacitive structure of the decorative element can act as a Q-factor adjustment element 53. In particular, the resistive, inductive and/or capacitive structure of the decorative element 102 is designed in such a way that it forms a standard NFC antenna together with a coil attached to the decorative element.

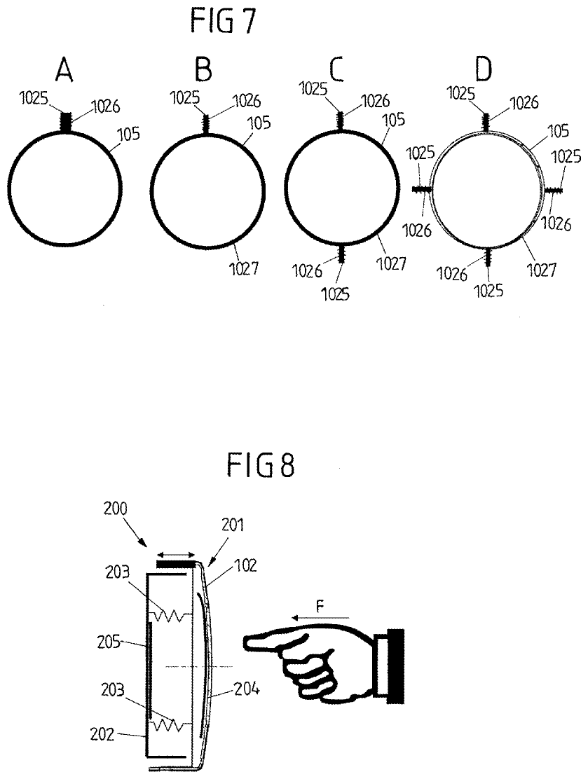

FIGS. 7A to 7D relate to various embodiments of a decorative ring 105 of an airbag cap arrangement according to the solution. In according with FIG. 7A, the decorative ring 105 comprises a VAP 1025, which, analogously to FIG. 4, is used as a carrier of a coil 1026 of an NFC antenna. It is also possible that both the VAP 1025 as well as the decorative ring 105 are the same carrier of an antenna coil. Thus, for example, a side of the decorative ring 105 can be provided with a metallization 1027 forming a part of an antenna structure (FIG. 7B). It is also possible that the decorative ring 105 comprises more than one VAP 1025 (FIGS. 7C and 7D) and/or a plurality of decorative rings are arranged on top of one another, which each comprise at least one VAP.

FIG. 8 shows a switch 200 according to the solution with a probe element in the form of a cover 201, which, for example, forms a decorative element 102. The decorative element 102 is, in particular, a manufacturer emblem plaque attached to an airbag cover. The cover 201 can be moved against the restoring force of two springs 203 relative to a base 202 of the switch 200. An apparatus comprising strain gauges 204, 205 on the cover 201 and/or on the base 202 for detecting an actuation of the probe element register the movement of the cover 201, whereby a switch signal is triggered. The strain gauges 204, 205 are not only used to detect a movement of the cover 201 but are each also designed as an NFC antenna. It is also conceivable that only one strain gauge is present, for example, for resistive measurement or only one of the strain gauges 204, 205 is used as an NFC antenna. In addition, it is also conceivable that, for example, the region of the cover 201, which forms the decorative element 102, is designed to be reversibly deformable (“clicker switch”).

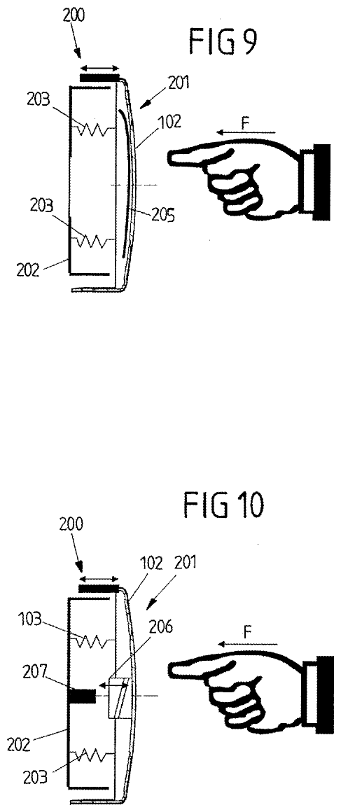

Another embodiment of the switch 200 is shown in FIG. 9. Here, a capacitive detection of a switching movement of the cover 201 takes place. In particular, this is made possible by means of the fact that the decorative element 102 forms a metallic NFC antenna structure, the movement of which is detectable by means of a capacitive measurement method. It is also conceivable that an electrically conductive structure 205 (e.g. a metallic coating) is arranged on a side of the cover 201 facing the base 202, via which structure a capacitive detection of a switch movement is possible. The conductive structure 205 forms an NFC antenna at the same time.

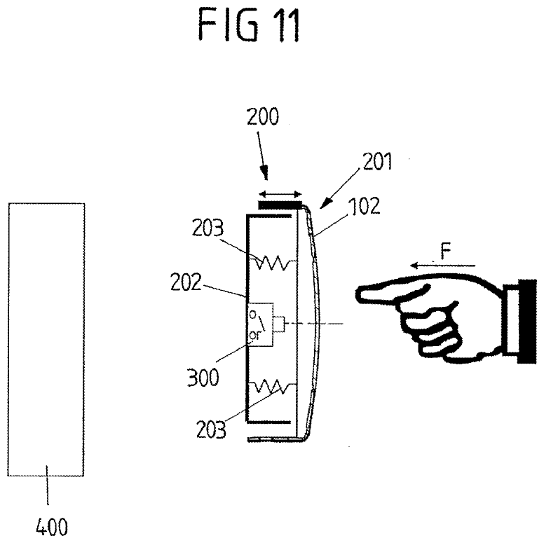

In addition or as an alternative, a switching movement of the cover 201 can also be inductively detected, cf. FIG. 10. For this purpose, the switch 200 comprises a coil 206 following a movement of the cover 201 and an iron core 207 arranged on the base 202. It is also possible that the iron core 207 is done without in the case of a metallic decorative element 102. The coil 206 is designed as an NFC antenna at the same time. Furthermore, it is possible that the voltage induced during a switch movement is used, for example, for generating a transmission signal (meaning for the energy supply of a corresponding transmitter) in order to wirelessly transmit a horn signal to a receiver or for the energy supply of an NFC unit.

For the energy supply of an NFC unit, for example, an NFC transmitter for transmitting a signal to a (e.g. vehicle-integrated) receiver 400, the switch 200 can also comprise a piezo element 300, cf. FIG. 11. The piezo element 300 (or, as an alternative, the coil described in the above) is arranged in such a way that it is deformable when actuating the cover 201, whereby the mechanical energy of the switch movement can at least be partially transformed into electrical energy. A power supply device with a piezo element and/or an inductive device allows, for example, an autonomous operation of the switch 200 and can be additionally fully integrated into the switch. Furthermore, the operating energy can be provided at any time, which, for example, is not ensured in the case of electrochemical energy storage devices. In addition, no line connection between the vehicle and switch is required, which improves manageability and security.

The energy generation illustrated in FIGS. 10 and 11 can naturally also be used in combination with the switches in FIGS. 8 and 9. Naturally, it is also conceivable that the switches can be operated using a conventional battery. In addition, it is conceivable that the switches have a light source for generating an optical feedback signal.

It is pointed out that, if a plurality of NFC antennas are present (e.g. in the embodiments in FIGS. 7 to 11), these can have the same reception and/or transmission frequency (actuation frequency), wherein, however, various functions are associated with the antennas in particular.

1. A vehicle component, comprising
a decorative element; and
at least one NFC antenna
wherein the NFC antenna is at least partially arranged on a component of the decorative element and/or is at least partially formed by a component of the decorative element.

2. The vehicle component as claimed in claim 1, wherein the component of the decorative element is made of an electrically conductive material or comprises a coating made of an electrically conductive material.

3. The vehicle component as claimed in claim 2, wherein the NFC antenna is at least partially formed by a structure of the electrically conductive material.

4. The vehicle component as claimed in claim 1, wherein the NFC antenna is at least partially formed by a coil arranged on the component of the at least one decorative element.

5. The vehicle component as claimed in claim 1, wherein the decorative element comprises at least one of a manufacturer emblem plaque and/or a decorative ring.

6. The vehicle component as claimed in claim 1, wherein the NFC antenna is at partially arranged on a projection of the decorative element, which is used to apply a voltage in the case of the production of a coating of the decorative element, or is formed by the projection.

7. The vehicle component as claimed in claim 1, wherein the decorative element comprises ferromagnetic elements that are formed and arranged in such a way that they support a guidance of an electromagnetic wave in the NFC antenna and/or shield the NFC antenna against exterior fields.

8. The vehicle component as claimed in claim 1, wherein the vehicle component is a steering wheel.

9. The vehicle component as claimed in claim 1, further comprising a transmitter and/or receiver connected to the NFC antenna.

10. The vehicle component as claimed in claim 1, further comprising a heating device and/or sensor device, wherein at least one part of a wire winding of the heating or of the sensor device forms an NFC antenna.

11. A switch to be arranged on a vehicle component with a probe element and an apparatus for detecting an actuation of the probe element, wherein the apparatus comprises an NFC antenna.

12. The switch as claimed in claim 11, wherein the apparatus is designed for the capacitive detection of the actuation of the probe element wherein an electrically conductive element of the apparatus forms the NFC antenna.

13. The switch as claimed in claim 11, wherein the apparatus is designed for the inductive detection of the actuation of the probe element wherein an inductive element of the apparatus forms the NFC antenna.

14. The switch as claimed in claim 11, wherein the apparatus is designed for the mechanical detection of the actuation of the probe element wherein at least one strain gauge of the apparatus forms the NFC antenna.

15. A steering wheel with a switch as claimed in claim 11, wherein the switch is designed to trigger a horn signal.

16. A method for producing a vehicle component as claimed in claim 1, comprising the steps:
providing or producing a decorative element; and
providing at least one NFC antenna,
wherein the NFC antenna is at least partially arranged on a component of the decorative element and/or is at least partially formed by a component of the decorative element.

17. The method as claimed in claim 16, wherein the arrangement of the NFC antenna on the component of the decorative element entails coating the component of the decorative element with an electrically conductive material, wherein the coating is created and/or structured in such a way that it at least partially forms the NFC antenna.
